(19) United States
(12) Patent Application Publication
(10) Pub. No.: US 2022/0250307 A1
(43) Pub. Date: Aug. 11, 2022

(54) FILM APPLICATION APPARATUS AND FILM APPLICATION METHOD

(71) Applicant: 3M INNOVATIVE PROPERTIES COMPANY, St. Paul, MN (US)

(72) Inventors: Takayoshi FUJINO, Sagamihara-city (JP); Yasuyuki DAIGO, Machida-city Tokyo (JP)

(21) Appl. No.: 17/608,124

(22) PCT Filed: May 26, 2020
(86) PCT No.: PCT/IB2020/054980

§ 371 Date: Nov. 1, 2021

(30) Foreign Application Priority Data
May 31, 2019 (JP) 2019-102319

(51) Int. Cl. B29C 63/02; B29C 63/00

(52) U.S. Cl. CPC B29C 63/02; B29L 2031/30; B29C 63/0004; B29C 63/0073

(57) ABSTRACT

To provide a film application apparatus and a film application method allowing a film to be applied to a target object partially having a recessed and projecting shape. A film application apparatus is a film application apparatus for applying a film to a target object. The film application apparatus includes a first roller, and a second roller. The first roller extends in a first direction intersecting a vertical direction. The first roller is configured to press the film disposed on an upper side of the target object from above, and is configured to move in a second direction intersecting the first direction and the vertical direction. The second roller extends in the first direction. The second roller is configured to press the film disposed on an upper side of the target object from above, and is configured to move in the second direction. The second roller is disposed on at least one of an upstream side and a downstream side of the first roller in a moving direction in the second direction.

### TECHNICAL FIELD

The present invention relates to a film application apparatus and a film application method.

### BACKGROUND ART

In recent years, target objects, such as a vehicle, are in some cases colored with a plurality of colors. In this case, coloring of at least one color out of a plurality of colors may be implemented through application of a film to a vehicle body. As such a technology, a technology described in Patent Document 1 has been known.

### SUMMARY OF INVENTION

Here, at the time of application of a film as in the above description, a film is applied to a target object having a substantially flat shape and a gentle inclination angle, such as a roof of a vehicle. However, in recent years, when a film is applied to various types of target objects, a target object may partially have a recessed and projecting shape as well as a portion having a gently variable shape. There has been a demand of implementing application to such a target object as well.

### Solution to Problem

A film application apparatus according to one embodiment of the present invention is a film application apparatus for applying a film to a target object. The film application apparatus includes a first roller, and a second roller. The first roller extends in a first direction intersecting a vertical direction. The first roller is configured to press the film disposed on an upper side of the target object from above, and is configured to move in a second direction intersecting the first direction and the vertical direction. The second roller extends in the first direction. The second roller is configured to press the film disposed on an upper side of the target object from above, and is configured to move in the second direction. The second roller is disposed on at least one of an upstream side and a downstream side of the first roller in a moving direction in the second direction.

### Advantageous Effects of Invention

According to the present invention, a film can be applied to a target object partially having a recessed and projecting shape.

### BRIEF DESCRIPTION OF DRAWINGS

FIG. 1 is a perspective view illustrating a part of a vehicle to which a film is applied by using a film application apparatus according to the present embodiment.

FIG. 2 is a side view illustrating the film application apparatus according to the present embodiment.

FIG. 3 is a front view illustrating the film application apparatus according to the present embodiment.

FIGS. 4a and 4b are schematic diagrams illustrating a detailed configuration of a first roller of a front-and-rear direction film application unit.

FIGS. 5a and 5b are schematic diagrams illustrating a detailed configuration of a width direction film application unit.

FIGS. 6a to 6c are schematic plan views illustrating how application is performed when a film is applied to a roof.

FIG. 7 is a front view illustrating a second roller.

FIG. 8 is a partially enlarged view of the second roller.

FIGS. 9a to 9c are schematic cross-sectional views illustrating an internal configuration of the second roller.

FIGS. 10a to 10c are schematic cross-sectional views illustrating an internal configuration of a second roller according to a modified example.

FIGS. 11a to 11c are schematic cross-sectional views illustrating an internal configuration of a second roller according to a modified example.

FIGS. 12a to 12f are schematic cross-sectional views illustrating an internal configuration of a second roller according to a modified example.

FIGS. 13a and 13b are schematic cross-sectional views illustrating an internal configuration of a second roller according to a modified example.

FIGS. 14a and 14b are diagrams illustrating another example of beads on a roof of a vehicle.

FIGS. 15a to 15c are schematic configuration diagrams illustrating a configuration around second rollers according to a modified example.

FIG. 16 is a schematic configuration diagram illustrating a configuration around the second rollers according to the modified example.

FIG. 17 is a schematic diagram illustrating how a film is applied by using the second rollers according to the modified example.

FIG. 18 is a schematic configuration diagram illustrating a configuration around a second roller according to a modified example.

### DESCRIPTION OF EMBODIMENTS

In the following, an embodiment of the present invention will be described in detail with reference to the attached drawings. Note that, in the following description, the same or equivalent elements are denoted by the same reference signs, and redundant description of those elements will be omitted.

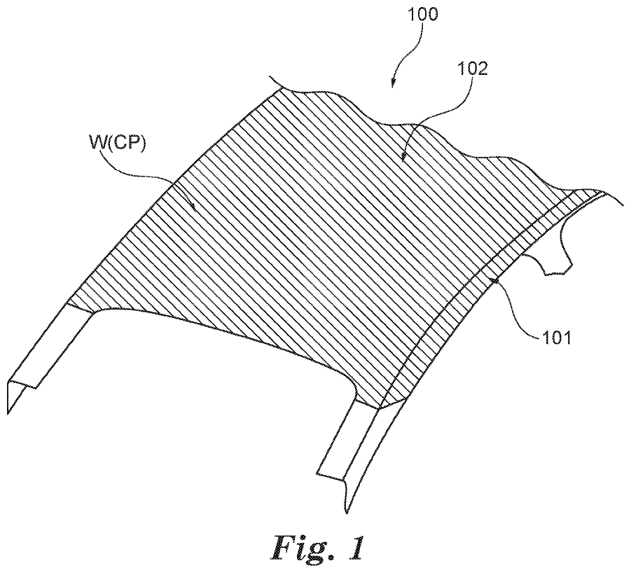

FIG. 1 is a perspective view illustrating a part of a vehicle to which a film is applied by using a film application apparatus according to the present embodiment. As illustrated in FIG. 1, a vehicle 100 as a target object of film application includes a side wall 101 and a roof 102. A film W covers a coverage area CP. The coverage area CP is a part of the vehicle 100, specifically, the roof 102 having a relatively gentle inclination angle, and an upper end side of the side wall 101 at least partially having a large inclination angle. Note that the “inclination angle” herein refers to an angle between a horizontal surface and a target surface to which a film is to be applied. In FIG. 1, a part of the vehicle 100 covered by the film W is hatched.

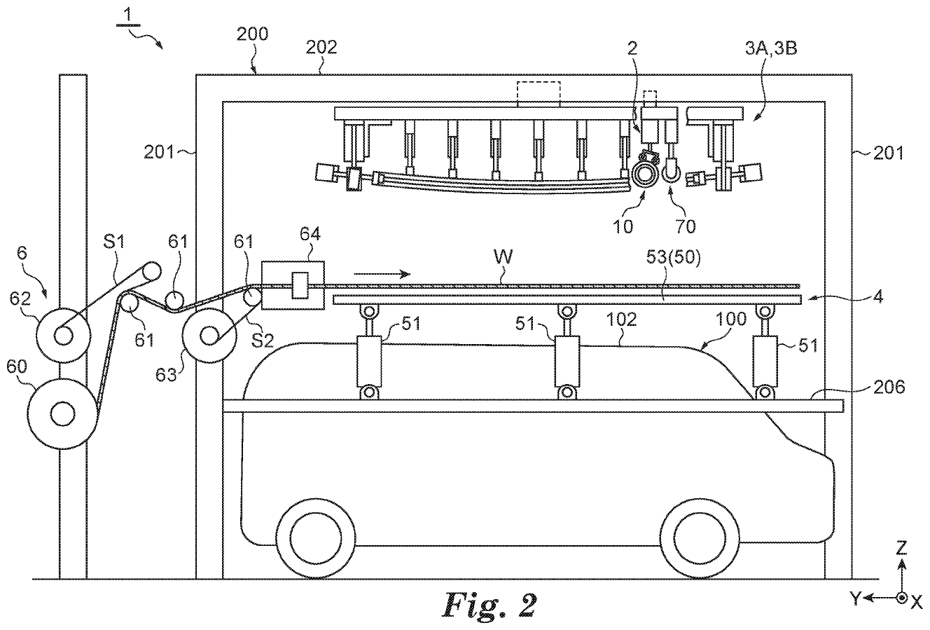

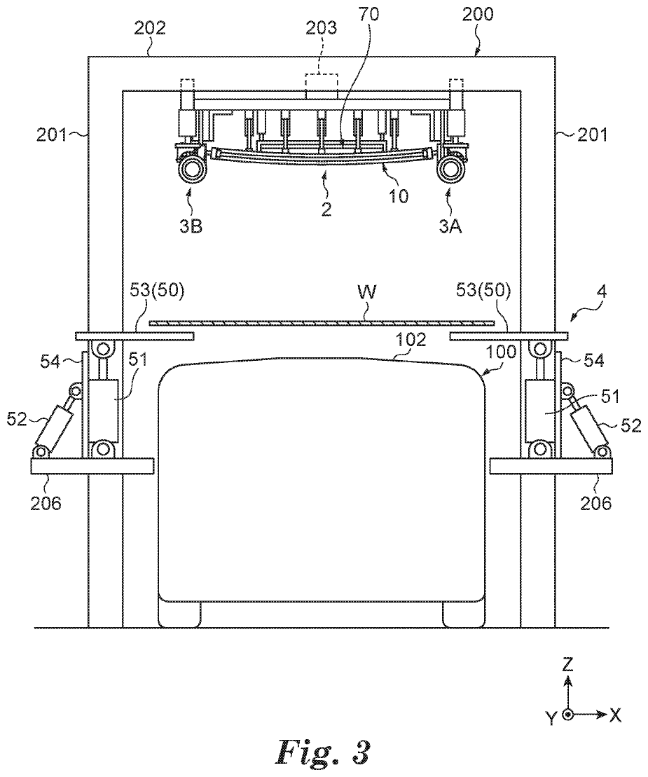

FIG. 2 is a side view illustrating the film application apparatus according to the present embodiment. FIG. 3 is a front view illustrating the film application apparatus according to the present embodiment. As illustrated in FIG. 2 and FIG. 3, a film application apparatus 1 includes a front-and-rear direction film application unit 2, width direction film application units 3A and 3B, a film support unit 4, and a film feeding unit 6. The vehicle 100 at the time of film application is disposed in a support frame 200 for supporting various mechanisms. The support frame 200 includes column parts 201 located at four corners, and a roof part 202 provided on upper ends of the column parts 201. Note that a width direction of the vehicle 100 in the horizontal direction is herein referred to as an X-axis direction (first direction), a front-and-rear direction of the vehicle 100 in the horizontal direction is referred to as a Y-axis direction (second direction), and the vertical direction is referred to as a Z-axis direction, with orientation of the vehicle 100 at the time of film application being a reference. One side of the vehicle 100 in the width direction (right side of the drawing sheet of FIG. 3) is referred to as a positive side in the X-axis direction, and another side (left side of the drawing sheet of FIG. 3) is referred to as a negative side in the X-axis direction. A rear side of the vehicle 100 is referred to as a positive side in the Y-axis direction, and a front side is referred to as a negative side in the Y-axis direction.

The front-and-rear direction film application unit 2 includes a first roller 10, and a second roller 70. The second roller 70 is disposed on a downstream side of the first roller 10 in a moving direction in the Y-axis direction. In the present embodiment, the front-and-rear direction film application unit 2 moves toward the positive side in the Y-axis direction. Thus, the second roller 70 is disposed on the negative side of the first roller 10 in the Y-axis direction. Note that a detailed configuration of the second roller 70 will be described later.

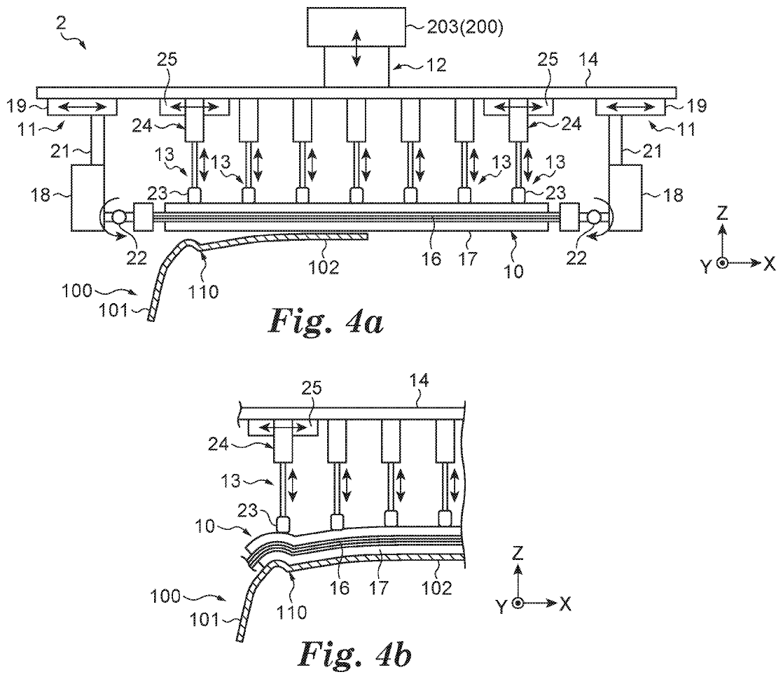

FIGS. 4a and 4b are schematic diagrams illustrating a detailed configuration of the first roller 10 of the front-and-rear direction film application unit 2. As illustrated in FIG. 4a, the front-and-rear direction film application unit 2 includes the first roller 10, tensile force application sections 11, a moving section 12, and pressing sections 13. The tensile force application sections 11, the moving section 12, and the pressing sections 13 are supported by a support member 14 having a rod-like shape and extending in the X-axis direction.

The first roller 10 extends in the X-axis direction. The first roller 10 presses the film W disposed on an upper side of the vehicle 100 from above, and is deformed in line with the shape of the vehicle 100. The first roller 10 moves in the Y-axis direction. Specifically, as illustrated in FIG. 4b, the first roller 10 has a flexible configuration allowing the first roller 10 to be deformed in line with the shape of the vehicle 100. The first roller 10 includes a core part 16 extending in the X-axis direction, and an application part 17 disposed on an outer peripheral side of the core part 16. The core part 16 is a cylindrical member extending in the X-axis direction.

It is desirable that a member having Shore A hardness of 60 to 90 be used for the core part 16. Specifically, it is preferable that Shore A hardness of the core part 16 be 60 or more, or 70 or more. With this configuration, the core part 16 can have rigidity in a degree that the first roller 10 can maintain a certain shape when a tensile force is applied by the tensile force application sections. Meanwhile, it is preferable that Shore A hardness of the core part 16 be 90 or less, or 80 or less. With this configuration, flexibility in a degree that the first roller 10 can deform in line with the shape of the vehicle 100 can be imparted to the first roller 10. Examples of materials having Shore A hardness as described above include rubber materials, such as chloroprene (CR) and nitrile (NBR). Those materials can be adopted as the core part 16. A diameter of the core part 16 may be set to approximately 6 mm to 30 mm. When a diameter of the core part 16 is set to 6 mm or more, mechanical designing of a joint part can be simplified. When a diameter of the core part 16 is set to 30 mm or less, flexibility of the first roller 10 can be secured. The application part 17 is disposed on an outer peripheral side of the core part 16, and has hardness that is at least lower than the hardness of the core part 16. The application part 17 is a part to come in contact with the film W, at the time of application of the film W. The application part 17 is only required to have a surface for applying the film W to a target surface. Although a cross-sectional shape of the application part 17 is not limited, a cylindrical member including the core part 16 disposed at the center may be used. It is desirable that a sponge-like member having Shore B hardness of 20 to 50 be used for the application part 17. Specifically, it is preferable that Shore B hardness of the application part 17 be 50 or less, or 40 or less. With such a configuration, satisfactory following performance of the application part 17 that the application part 17 keeps in line with the shape of the vehicle 100 can be secured. Meanwhile, it is preferable that Shore B hardness of the application part 17 be 20 or more, or 30 or more. With such a configuration, elasticity in a degree of enabling operation control of the first roller 10 performed by first pressing rollers 23 can be maintained. Examples of materials having Shore B hardness as described above include sponge rubber, such as porous EPDM or CR rubber. It is preferable that an outer diameter of the application part 17 be 50 mm to 100 mm. It is desirable that an outer diameter of the application part 17 be set to 50 mm or more, so that the outer diameter of the application part 17 is greater than the diameter of the core part 16. Meanwhile, it is preferable that an outer diameter of the application part 17 be set to 100 mm or less, because rubber having a diameter greater than 100 mm is not easily available from reasons in manufacturing. The length of each of the core part 16 and the application part 17 in the X-axis direction may be greater than the dimension of the vehicle 100 in the X-axis direction. The core part 16 is longer than the application part 17. A part of the core part 16 is exposed from both end portions of the application part 17.

The tensile force application section 11 applies a tensile force to at least one end side of the first roller 10 in the X-axis direction. The tensile force is directed toward an outer side in the X-axis direction. In the present embodiment, the tensile force application section 11 is provided on each of both end sides of the first roller 10. The tensile force application section 11 includes a support part 18 that supports an end portion of the first roller 10, a drive part 19 that can move the support part 18 in the X-axis direction, and a coupling part 21 that couples the drive part 19 and the support part 18.

The support part 18 is disposed on an outer side of the first roller 10 in the X-axis direction so that the support part 18 faces a tip end portion of the first roller 10. The support part 18 and the first roller 10 are connected with a universal joint 22. The universal joint 22 is a joint allowing an angle between two members to be freely changed. With this configuration, the first roller 10 can be freely deformed while the first roller 10 is supported by the support part 18.

The drive part 19 is provided on the support member 14, and can move the support part 18 and the coupling part 21 along the support member 14 in the X-axis direction. The drive part 19 includes a servomotor or the like. With this configuration, when the drive part 19 moves the support part 18 in the X-axis direction, the position of an end portion of the first roller 10 is also moved. Specifically, when the drive part 19 moves the support part 18 toward an outer side of the first roller 10 in the X-axis direction, a tensile force to be applied to the first roller 10 is increased. In contrast, when the drive part 19 moves the support part 18 toward an inner side of the first roller 10 in the X-axis direction, a tensile force to be applied to the first roller 10 is reduced.

The moving section 12 moves the first roller 10 in the vertical direction. In the present embodiment, the moving section 12 includes a servomotor provided on an upper surface side of the support member 14 at a center position of the support member 14 in the X-axis direction. The moving section 12 is connected to a guide rail 203 of the support frame 200. The moving section 12 moves the support member 14 in the vertical direction, and can thereby move the entire tensile force application sections 11 and first roller 10 in the vertical direction. With this configuration, the moving section 12 can adjust the position of the first roller 10 in the vertical direction, and can deform the first roller 10 into a shape in line with the roof 102 and the side wall 101 of the vehicle 100. Note that the moving section 12 need not be capable of moving the entire first roller 10 in the vertical direction. For example, the moving section 12 may be capable of moving only an end portion of the first roller 10. The moving section 12 can move the entire support member 14 along the guide rail 203 in the Y-axis direction. With this configuration, the moving section 12 can move the first roller 10, the tensile force application sections 11, and the pressing sections 13 in the Y-axis direction.

The pressing section 13 includes a first pressing roller 23, and a cylinder 24. The first pressing roller 23 presses the first roller 10 toward the vehicle 100, and moves together with the first roller 10 at the same time. The cylinder 24 has an upper end connected to the support member 14, and a lower end connected to the first roller 10. Thus, through extension and retraction of the cylinder 24, a pressing force of the first pressing roller 23 is adjusted. A plurality of pressing sections 13 are provided along the X-axis direction at regular intervals. Here, each of the pressing sections 13 on both end sides in the X-axis direction, out of the plurality of pressing sections 13, is provided with a drive part 25 that moves the first pressing roller 23 and the cylinder 24 in the X-axis direction. With this configuration, the pressing sections 13 on both end sides can perform positional adjustment in the X-axis direction, so that the first pressing rollers 23 can constantly press an upper side of a laser weld 110. The rest of pressing sections 13 need not include the drive part 25.

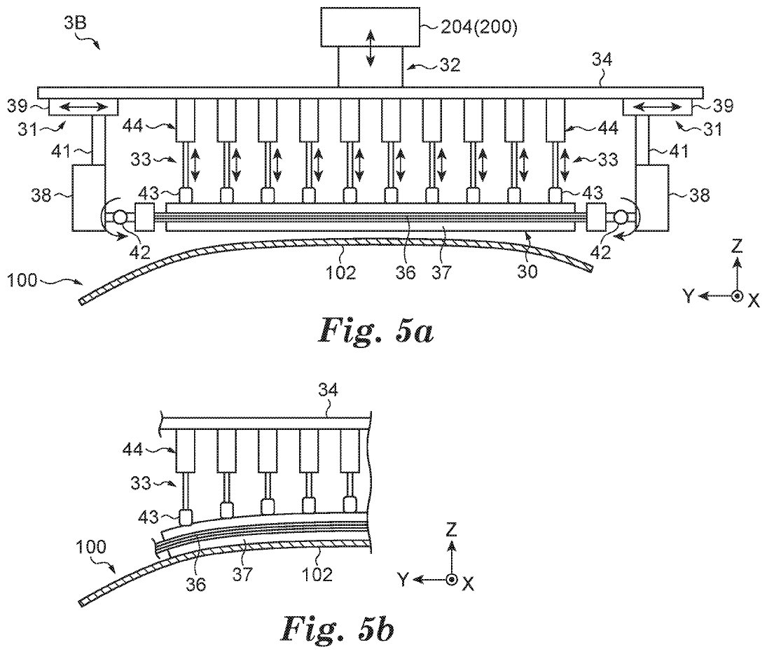

FIGS. 5a and 5b are schematic diagrams illustrating a detailed configuration of the width direction film application unit 3B. As illustrated in FIG. 5a, the width direction film application unit 3B includes a roller 30, tensile force application sections 31, a moving section 32, and pressing sections 33. The tensile force application sections 31, the moving section 32, and the pressing sections 33 are supported by a support member 34 having a rod-like shape and extending in the Y-axis direction.

The roller 30 extends in the Y-axis direction. The roller 30 presses the film W disposed on an upper side of the vehicle 100 from above, and is deformed in line with the shape of the vehicle 100. The roller 30 moves in the X-axis direction. Specifically, as illustrated in FIG. 5b the roller 30 has a flexible configuration allowing the roller 30 to be deformed in line with the shape of the vehicle 100. The roller 30 includes a core part 36 extending in the Y-axis direction, and an application part 37 disposed on an outer peripheral side of the core part 36. Note that the roller 30 has the similar configuration to the configuration of the first roller 10 except for an extending direction, and thus detailed description of the roller 30 will be omitted.

The tensile force application section 31 applies a tensile force to at least one end side of the roller 30 in the Y-axis direction. The tensile force is directed toward an outer side in the Y-axis direction. In the present embodiment, the tensile force application section 31 is provided on each of both end sides of the roller 30. The tensile force application section 31 includes a support part 38 that supports an end portion of the roller 30, a drive part 39 that can move the support part 38 in the Y-axis direction, and a coupling part 41 that couples the drive part 39 and the support part 38. The tensile force application section 31 has the similar configuration to the configuration of the tensile force application section 11 except for a direction in which a tensile force is applied, and thus detailed description of the tensile force application section 31 will be omitted.

The support part 38 is disposed on an outer side of the roller 30 in the X-axis direction so that the support part 38 faces a tip end portion of the roller 30. The support part 38 and the roller 30 are connected with a universal joint 42. The universal joint 42 is a joint allowing an angle between two members to be freely changed. With this configuration, the roller 30 can be freely deformed while the roller 30 is supported by the support part 38.

The moving section 32 moves the roller 30 in the vertical direction. The moving section 32 can move the entire support member 34 along a guide rail 204 in the X-axis direction. The moving section 32 moves the roller 30 at positions of an edge portion of the roof 102 and the side wall 101 of the vehicle 100. The moving section 32 has the similar configuration to the configuration of the moving section 12 except for a moving direction, and thus detailed description of the moving section 32 will be omitted.

The pressing section 33 includes a second pressing roller 43, and a cylinder 44. The second pressing roller 43 presses the roller 30 toward the vehicle 100, and moves together with the roller 30 at the same time. The cylinder 44 has an upper end connected to the support member 34, and a lower end connected to the roller 30. Thus, through extension and retraction of the cylinder 44, a pressing force of the second pressing roller 43 is adjusted. A plurality of pressing sections 33 are provided along the Y-axis direction at regular intervals.

As illustrated in FIG. 2 and FIG. 3, a film support unit 4 is a mechanism that allows the film W to be disposed above the vehicle 100. The film support unit 4 includes frame structure 50 that support outer edges of the film W at positions on outer peripheral sides of the vehicle 100, and drive parts 51 and 52 that drive the frame structure 50. Specifically, the frame structure 50 include a pair of plate-like members 53 disposed on both sides of the vehicle 100 in the X-axis direction, and a pair of plate-like members (not illustrated) disposed on both sides of the vehicle 100 in the Y-axis direction. Note that, in FIG. 3 and other figures corresponding to FIG. 3, plate-like members and drive parts disposed on both sides in the Y-axis direction are omitted. The plate-like member 53 extends in the XY plane and extends in the Y-axis direction, at a height position near the roof 102 of the vehicle 100. The plate-like member 53 is made of a material having flexibility, such as a metal plate of stainless steel of the like having a thickness of 1 mm to 3 mm.

The drive part 51 is a mechanism that drives the plate-like member 53 in the vertical direction. The drive part 51 includes a cylinder extending in the vertical direction. An upper end of the drive part 51 is fixed to a lower surface of an edge portion of the plate-like member 53 located on an outer side in the X-axis direction, and a lower end of the drive part 51 is fixed to a table part 206 of the support frame 200. Further, a plurality of drive parts 51 are provided for one plate-like member 53. For example, when three drive parts 51 are provided, the three drive parts 51 are disposed to be spaced apart from each other in the Y-axis direction at predetermined intervals. A first drive part 51 is disposed at a front end portion of the plate-like member 53. A second drive part 51 is disposed at a substantially central position of the plate-like member 53 in the Y-axis direction. A third drive part 51 is disposed at a rear end portion of the plate-like member 53. Note that the number and the positions of the drive parts 51 are not particularly limited. Specifically, the number of drive parts 51 may be greater than three, and may be five, for example. Each of the drive parts 51 is independently extendible and retractable. Thus, the plate-like member 53 partially moves in the vertical direction, at respective positions where the drive parts 51 are provided. Thus, the frame structure 50 can adjust a distance between the film W and the vehicle 100, at the time when application of the film W is started. The frame structure 50 can be curved in line with the curved shape of the vehicle 100. Further, when the film W is applied to the vehicle 100 by using the first roller 10, the frame structure 50 can be deformed in line with the curved shape of the vehicle 100 at application positions.

The drive part 52 (not illustrated in FIG. 2) is a mechanism that drives the plate-like member 53 in the X-axis direction. The drive part 52 includes a cylinder extending in such an inclined manner that an inner side in the X-axis direction is located at a higher position. An upper end of the drive part 52 is fixed to a coupling member 54 coupled to the drive part 51, and a lower end of the drive part 52 is fixed to the table part 206. The number of drive parts 52 to be provided for one plate-like member 53 is not particularly limited. The drive part 52 need not be inclined, and may be disposed to extend straight in the X-axis direction. When the drive part 52 is retracted, the plate-like member 53 is pulled toward an outer side in the X-axis direction. With this configuration, the frame structure 50 can apply a tensile force to the film W, toward an outer side in a planar direction. Note that, when a tensile force is applied to the film W, plate-like members (not illustrated) disposed to face each other in the Y-axis direction can also pull the film W toward an outer side in the Y-axis direction.

As illustrated in FIG. 2, the film feeding unit 6 is a mechanism that feeds the film W to the frame structure 50. The film feeding unit 6 includes a roller part 60, a plurality of guide rollers 61, protective-sheet collecting rollers 62 and 63, and a position aligning part 64. The roller part 60 feeds the film W formed in a rolled shape. The plurality of guide rollers 61 guide the film W fed by the roller part 60. The protective-sheet collecting roller 62 rolls up a protective sheet S1 peeling from an upper surface of the fed film W. The protective-sheet collecting roller 63 rolls up a protective sheet S2 peeling from a lower surface of the fed film W. The position aligning part 64 aligns the position of the film W, at a position before reaching the frame structure 50. A tip end portion of the film W fed from the position aligning part 64 is held by a holding mechanism (not illustrated), and is thereby moved toward the negative side in the Y-axis direction. After the tip end portion of the film W reaches an end portion of the frame structure 50 on the negative side in the Y-axis direction, both edge portions of the film W are applied to an upper surface of the plate-like members 53 located on both sides of the frame structure 50. The film W is cut off at a position on the positive side of the frame structure 50 in the Y-axis direction.

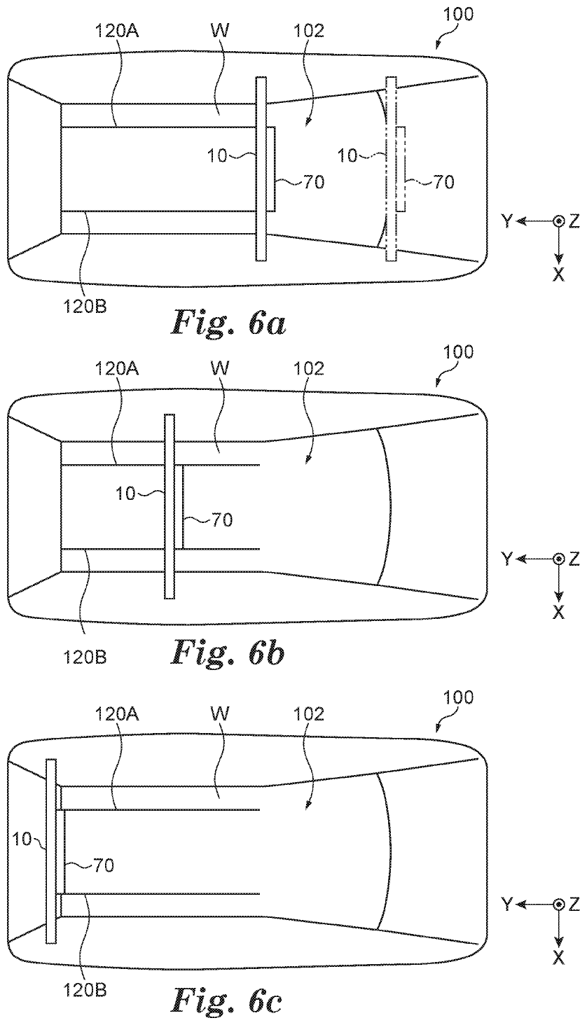

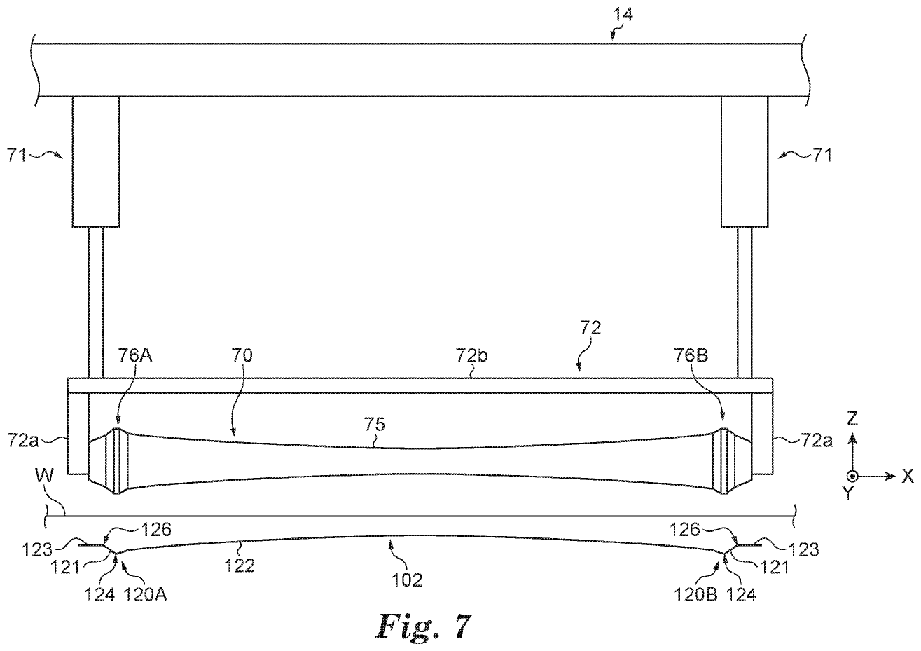

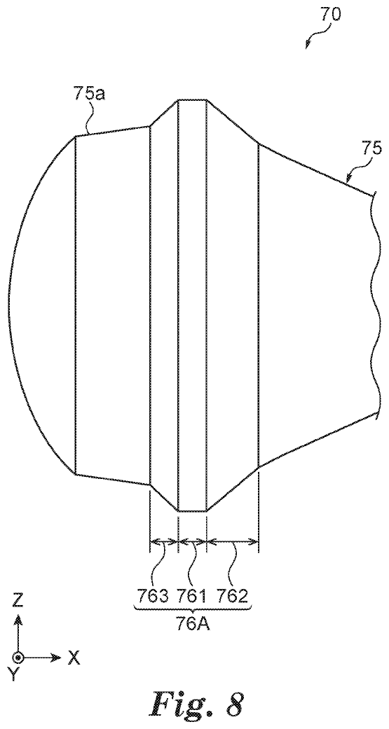

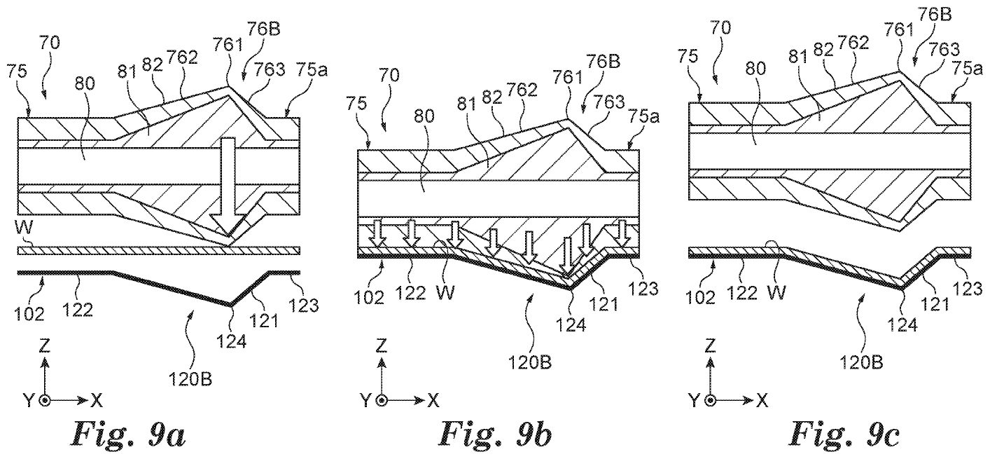

Next, with reference to FIG. 6a to FIG. 9c, the second roller 70 will be described in detail. FIGS. 6a to 6c are schematic plan views illustrating how application is performed when the film W is applied to the roof 102. FIG. 7 is a front view illustrating the second roller 70. FIG. 8 is a partially enlarged view of the second roller 70. FIGS. 9a to 9c are schematic cross-sectional views illustrating an internal configuration of the second roller 70.

As illustrated in FIGS. 6a to 6c, the second roller 70 is used to satisfactorily apply the film W to portions near beads 120A and 120B, when the beads 120A and 120B are formed on the roof 102. The beads 120A and 120B are formed in an area on a rear side of the roof 102. The beads 120A and 120B extend in the front-and-rear direction, in a state that the beads 120A and 120B are spaced apart from each other in a vehicle width direction and extend in parallel with each other. As illustrated in FIG. 7, each of the beads 120A and 120B includes an inclined portion 121. The inclined portion 121 is inclined in such a manner that an outer side in the X-axis direction is located at a higher position than an inner side. A main body part 122, which is a part of the roof 102 between the inclined portion 121 of the bead 120A and the inclined portion 121 of the bead 120B, extends in a substantially parallel manner with the XY plane and is smoothly curved. A main body part 123, which is a part of the roof 102 on an outer side of each of the inclined portions 121 of the bead 120A and the bead 120B in the X-axis direction, extends in a substantially parallel manner with the XY plane and is smoothly curved. Coupling portions between the main body part 122 and each of the inclined portions 121 are portions at which a shape sharply changes, in a recessed and projecting shape of the roof 102. Such portions are portions at which the shape of the continuously extending main body part 122 and the shape of each of the inclined portions 121 continuously inclined at a predetermined angle are discontinuous. Such portions are referred to as discontinuous portions 124 of a recessed and projecting shape of the roof 102. Coupling portions between the main body part 123 and each of the inclined portions 121 are referred to as discontinuous portions 126.

The second roller 70 extends at positions corresponding to the beads 120A and 120B, and in an area between the beads 120A and 120B. As illustrated in FIGS. 6a to 6c, the second roller 70 is disposed on a downstream side of the first roller 10 in a moving direction, and moves together with the first roller 10. The first roller 10 presses the film W entirely in the X-axis direction from a front side toward a rear side of the roof 102. Then, the second roller 70 presses the film W at positions corresponding to the positions near the beads 120A and 120B.

As illustrated in FIG. 7, the second roller 70 is supported by the support member 14 via cylinders 71 and a support frame 72. The cylinder 71 has an upper end connected to the support member 14, and a lower end connected to the support frame 72. Thus, through extension and retraction of the cylinder 71, a pressing force of the second roller 70 is adjusted. Although a pair of cylinders 71 is provided to be spaced apart in the X-axis direction, the number of cylinders 71 is not particularly limited. The support frame 72 includes a pair of support parts 72a that supports the second roller 70 in a rotatable manner at both end portions of the second roller 70 in the X-axis direction, and a frame main body part 72b that supports the pair of support parts 72a at an upper end portion of the pair of support parts 72a. The support parts 72a support the second roller 70 in a rotatable manner.

The cylinder 71 can move the second roller 70 in the vertical direction with respect to the support member 14. Thus, the second roller 70 can change a relative position with respect to the first roller 10, in the vertical direction.

The second roller 70 includes a main body part 75, and large diameter parts 76A and 76B. The main body part 75 is a part in which a diameter smoothly varies in line with the shape of the roof 102. Each of the large diameter parts 76A and 76B is a part at which a diameter is locally increased at a part in the X-axis direction. The large diameter parts 76A and 76B are formed at positions corresponding to the beads 120A and 120B, respectively.

FIG. 8 illustrates the large diameter part 76A. Note that the large diameter part 76B has a laterally inverted shape of the large diameter part 76A, and thus description of the large diameter part 76B will be omitted. As illustrated in FIG. 8, the large diameter part 76A includes an apex portion 761, and inclined portions 762 and 763. The apex portion 761 is a portion having the largest diameter. The inclined portion 762 is formed on an inner side of the apex portion 761 in the X-axis direction. The inclined portion 762 extends in a manner that an outer side in the X-axis direction is located further on an outer peripheral side than an inner side. The inclined portion 763 is formed on an outer side of the apex portion 761 in the X-axis direction. The inclined portion 763 extends in a manner that an inner side in the X-axis direction is located further on an outer peripheral side than an outer side. An inclination angle of the inclined portion 762 with respect to the X axis is greater than an inclination angle of the gently inclined main body part 75. An inclination angle of the inclined portion 763 with respect to the X axis is greater than an inclination angle of an outer end portion 75a of the gently inclined main body part 75.

Of the second roller 70, the apex portion 761 presses the discontinuous portion 124, the inclined portion 763 presses the inclined portion 121, the inclined portion 763 and the main body part 75 press the main body part 122, and the outer end portion 75a of the main body part 75 presses the main body part 123.

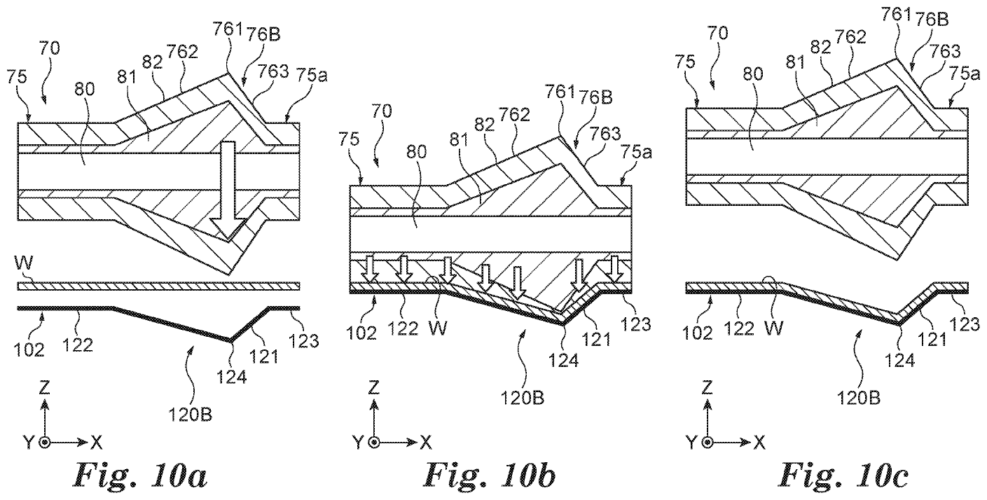

With reference to FIGS. 9a to 9c, a cross-sectional structure of the second roller 70 will be described. Note that FIGS. 9a to 9c only illustrate the large diameter part 76B. The large diameter part 76A also has the similar configuration, and thus description of the large diameter part 76A will be omitted. For the sake of better understanding, in FIGS. 9a to 9c, the thickness of the roof 102 is omitted, and only the shape of an applied surface is illustrated. The apex portion 761 is illustrated as a corner portion. The same also applies to FIG. 10a to FIG. 13b. As illustrated in FIG. 9a, the second roller 70 includes a first layer 81, and a second layer 82 on an outer peripheral side. The first layer 81 and the second layer 82 are formed in a radial direction, and are formed of materials different from each other. The first layer 81 is supported by an outer peripheral surface of a shaft part 80 of the second roller 70. An outer peripheral surface of the second layer 82 constitutes an outer peripheral surface of the second roller 70. Thus, the shape of the outer peripheral surface of the second layer 82 is a shape similar to the outer peripheral surface of the second roller 70 described above. The first layer 81 is made of a material harder than a material of the second layer 82. It is preferable that hardness of the first layer 81 be Shore A hardness or Shore B hardness of 20 to 90, or Shore B hardness of 60 to 90 when the first layer 81 is made of a foamed material. It is preferable that hardness of the second layer 82 be Shore A hardness or Shore B hardness of 10 to 45, or Shore B hardness of 10 to 35 when the second layer 82 is made of a foamed material. As a material of the first layer 81 and the second layer 82, silicone, urethane, and butyl rubber may be adopted, for example. The first layer 81 and the shaft part 80 may be integrated with each other. In this case, a material of the first layer 81 is metal or resin.

The first layer 81 of the second roller 70 has a thickness varying depending on a position in the X-axis direction. Specifically, in a portion corresponding to the main body part 75, an outer peripheral surface of the first layer 81 has a shape substantially in parallel with an outer peripheral surface of the main body part 75. Note that an outer peripheral surface of the shaft part 80 need not have a shape substantially in parallel with an outer peripheral surface of the main body part 75, and may have a shape having a constant diameter in the X-axis direction. The first layer 81 is formed such that a diameter of the first layer 81 is increased in line with the large diameter part 76B. Specifically, in a portion corresponding to the inclined portion 762, the first layer 81 has a diameter increased from an inner side toward an outer side in the X-axis direction, as with the inclined portion 762. In a portion corresponding to the inclined portion 763, the first layer 81 has a diameter increased from an outer side toward an inner side in the X-axis direction, as with the inclined portion 763. In a portion corresponding to the apex portion 761, the first layer 81 has the largest diameter, as with the apex portion 761.

The second layer 82 of the second roller 70 has a thickness varying depending on a position in the X-axis direction. The thickness is defined by a dimension between an outer peripheral surface of the first layer 81 and an outer peripheral surface of the second layer 82. Note that an outer peripheral surface of the first layer 81 and an inner peripheral surface of the second layer 82 have a similar shape. In the main body part 75, the thickness of the second layer 82 is a substantially constant thickness. In the large diameter part 76B, the thickness of the second layer 82 is the smallest at the apex portion 761. I the inclined portions 762 and 763, the thickness of the second layer 82 is gradually smaller as closer to the apex portion 761.

With the configuration as described above, the second roller 70 includes a portion having different hardness along the X-axis direction. Specifically, the portion having different hardness is formed at a portion of the second roller 70 corresponding to the discontinuous portion 124 of a recessed and projecting shape of the roof 102, and is harder than at least a part of the other portion. Here, the “portion having different hardness” refers to the large diameter part 76B. The large diameter part 76B is harder than the main body part 75. A portion of the second roller 70 corresponding to the discontinuous portion 124 of a recessed and projecting shape, i.e., the large diameter part 76B, is harder than the first roller 10.

Here, the “hardness” as used herein is described. Hardness as used herein not only indicates hardness of only an outer peripheral surface of the second roller 70, but refers to hardness of the shaft part 80, the first layer 81, and the second layer 82 altogether. In comparison with hardness of the main body part 75, it is preferable that hardness of the apex portion 761 of the second roller 70 have a value of difference between absolute values of Shore A hardness or Shore B hardness of 5 or more, more preferably 10 or more.

Next, the operation and effect of the film application apparatus 1 according to the present embodiment will be described.

The film application apparatus 1 according to the present embodiment is a film application apparatus for applying a film to a target object. The film application apparatus includes a first roller, and a second roller. The first roller extends in a first direction intersecting a vertical direction. The first roller is configured to press the film disposed on an upper side of the target object from above, and is configured to move in a second direction intersecting the first direction and the vertical direction. The second roller extends in the first direction. The second roller is configured to press the film disposed on an upper side of the target object from above, and is configured to move in the second direction. The second roller is disposed on a downstream side of the first roller in a moving direction in the second direction.

The film application apparatus 1 includes the second roller 70, in addition to the first roller 10. In this case, pressing can be performed in the following manner. Specifically, the first roller 10 can apply a film to the entire target object, whereas the second roller 70 can satisfactorily apply a film to a portion at which a recessed and projecting shape is partially formed, such as the beads 120A and 120B. With the configuration described above, the film application apparatus 1 can apply a film to a target object partially having a recessed and projecting shape.

The second roller 70 includes a portion having different hardness along the X-axis direction. In this case, at portions of the second roller 70 corresponding to the beads 120A and 120B, hardness of the second roller 70 can be set to such hardness as to allow the film W to be easily applied.

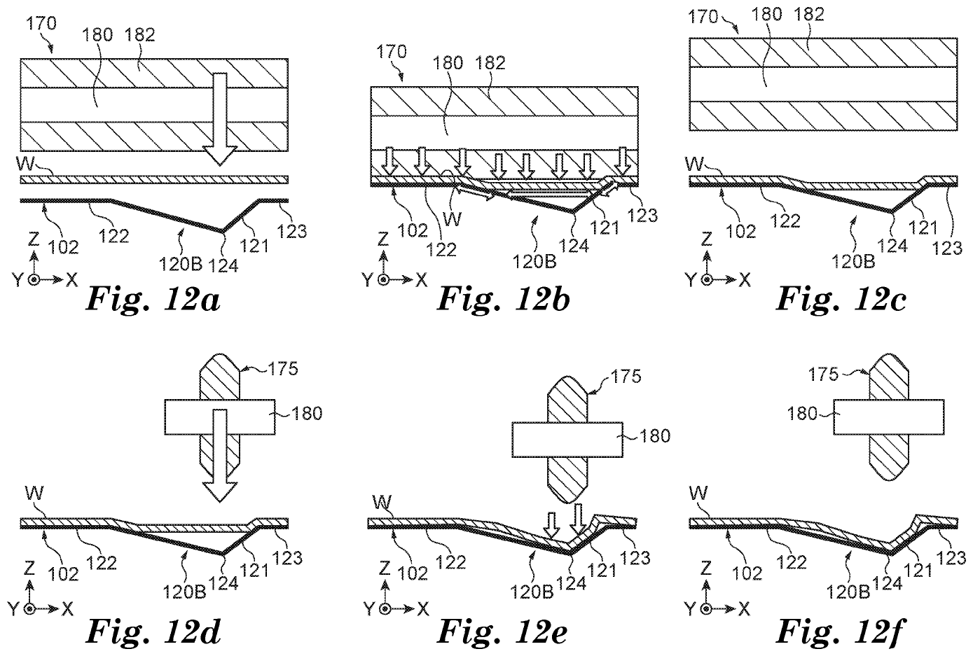

Here, a second roller 170 illustrated in FIGS. 12a to 12f will be described. The second roller 170 of FIGS. 12a to 12f includes a shaft part 180, and a second layer 182. The second layer 182 does not include a large diameter part corresponding to the bead 120B. In this case, as illustrated in FIGS. 12b and 12c, application of the film W near the discontinuous portion 124 may be unsatisfactory. In this case, as illustrated in FIGS. 12d to 12f, a small-sized roller 175 needs to be used to partially press the film W toward the discontinuous portion 124 of the bead 120B. However, the small-sized roller 175 may fail to press a wide area, and thus application of the film W around the discontinuous portion 124 may be unsatisfactory.

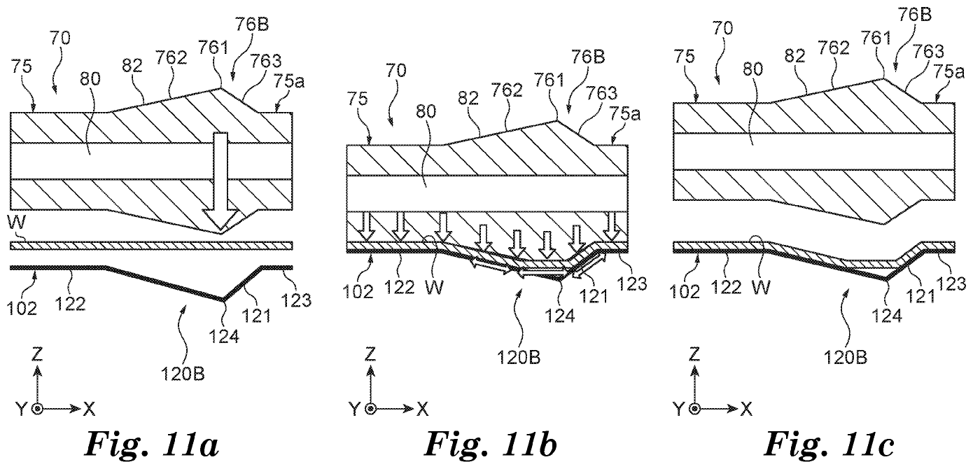

The second roller 70 illustrated in FIGS. 11a to 11c includes the large diameter part 76B, but consists entirely of the second layer 182. In this case, as illustrated in FIGS. 11b and 11c, the large diameter part 76B presses the film W toward the discontinuous portion 124. In this manner, the film W can be pressed down to a deep position of the bead 120B. However, a pressing force near the apex portion 761 may be less than tension of the film W near the discontinuous portion 124. In this case, before the film W reaches the discontinuous portion 124, a deformed amount of the apex portion 761 may be increased, and thus the film W may not be satisfactorily applied to the discontinuous portion 124.

In light of this, as illustrated in FIGS. 9b and 9c, the second roller 70 according to the present embodiment is hard at the large diameter part 76B. Thus, a pressing force near the apex portion 761 is greater than tension of the film W near the discontinuous portion 124, allowing the film W to be applied to the discontinuous portion 124.

As described above, the portion having different hardness (large diameter parts 76A and 76B) is formed at a portion of the second roller 70 corresponding to the discontinuous portion 124 of a recessed and projecting shape of the roof 102, and is harder than at least a part of the other portion (main body part 75). The roof 102 has a recessed and projecting shape, and a portion (large diameter parts 76A and 76B) of the second roller 70 corresponding to the discontinuous portion 124 of the recessed and projecting shape is harder than the first roller 10. With this configuration, as illustrated in FIGS. 9b and 9c, when the second roller 70 presses the film W at the large diameter parts 76A and 76B being hard portions, the film W can be satisfactorily applied to the discontinuous portions 124.

The second roller 70 is capable of changing a relative position with respect to the first roller 10, in the vertical direction. In this case, the second roller 70 can apply the film W with an appropriate pressing force for applying the film W to the beads 120A and 120B.

The second roller 70 includes the large diameter parts 76A and 76B, at which a diameter is increased at a part in the X-axis direction. In this case, the film W can be satisfactorily pressed toward the discontinuous portions 124 having a downwardly recessed shape.

The second roller 70 includes the first layer 81, and the second layer 82 on an outer peripheral side. The first layer 81 and the second layer 82 are formed in a radial direction, and are formed of materials different from each other. In this case, hardness of the second roller 70 can be more easily adjusted, as compared to a case where hardness is adjusted with only one material.

The first layer 81 of the second roller 70 has a thickness varying depending on a position in the X-axis direction. In this case, through adjustment of the thickness of the first layer 81, hardness of the second roller 70 can be easily adjusted. Specifically, the hard first layer 81 is formed to have a shape corresponding to the beads 120A and 120B, and the second layer 82 is formed on an outer peripheral surface of the hard first layer 81. In this manner, hardness of the second roller 70 can be easily adjusted.

The second layer 82 of the second roller 70 has a thickness varying depending on a position in the X-axis direction. The thickness is defined by a dimension between an outer peripheral surface of the first layer 81 and an outer peripheral surface of the second layer 82. With this configuration, through adjustment of the thickness, hardness of the second roller 70 can be easily adjusted. Specifically, the second layer 82 being a soft material is formed to be thin near the apex portion 761. In this manner, hardness of the large diameter parts 76A and 76B can be easily increased.

The second roller 70 is disposed on a downstream side of the first roller 10 in a moving direction in the Y-axis direction. In this case, the first roller 10 is used to apply the film W to the roof 102 entirely in the X-axis direction. Then, the second roller 70 can press the film W toward portions corresponding to the beads 120A and 120B in an appropriate pressing manner. With this configuration, the film W can be satisfactorily applied over the entire roof 102.

The shape of the second roller 70 is not limited to the shape of the embodiment described above. For example, as illustrated in FIGS. 10a to 10c, the thickness of the second layer 82 may be constant in the large diameter parts 76A and 76B. Even in such a case, a portion near the apex portion 761 has a large thickness of the hard first layer 81, and is therefore harder than the main body part 75. Thus, as illustrated in FIGS. 10a and 10b, a pressing force near the apex portion 761 is greater than tension of the film W near the discontinuous portion 124, allowing the film W to be applied to the discontinuous portion 124.

Note that configurations of the second rollers as illustrated in FIGS. 11a to 11c and FIGS. 12a to 12f are not excluded from the present invention.

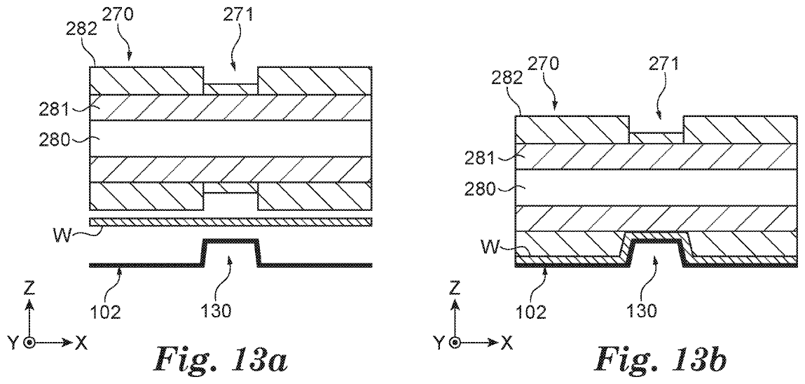

The shape of the second roller may be changed as appropriate, according to the shape of a bead. For example, as illustrated in FIGS. 13a and 13b, a bead 130 having an upwardly projecting shape may be formed on the roof 102. In this case, a second roller 270 may have a recessed portion at a position corresponding to the bead 130. For example, the second roller 270 includes a shaft part 280 and a first layer 281, which have outer peripheral surfaces having a uniform shape. In addition, the second roller 270 includes a second layer 282 in which a small diameter part 271 is formed. The small diameter part 271 is a part at which a diameter is partially reduced. At the small diameter part 271, the second layer 282 being a soft material is thin. Thus, the small diameter part 271 is harder than the other portion. In this case, as illustrated in FIG. 13b, the film W can be applied to the bead 130, with the small diameter part 271 being deformed into a shape in line with the bead 130.

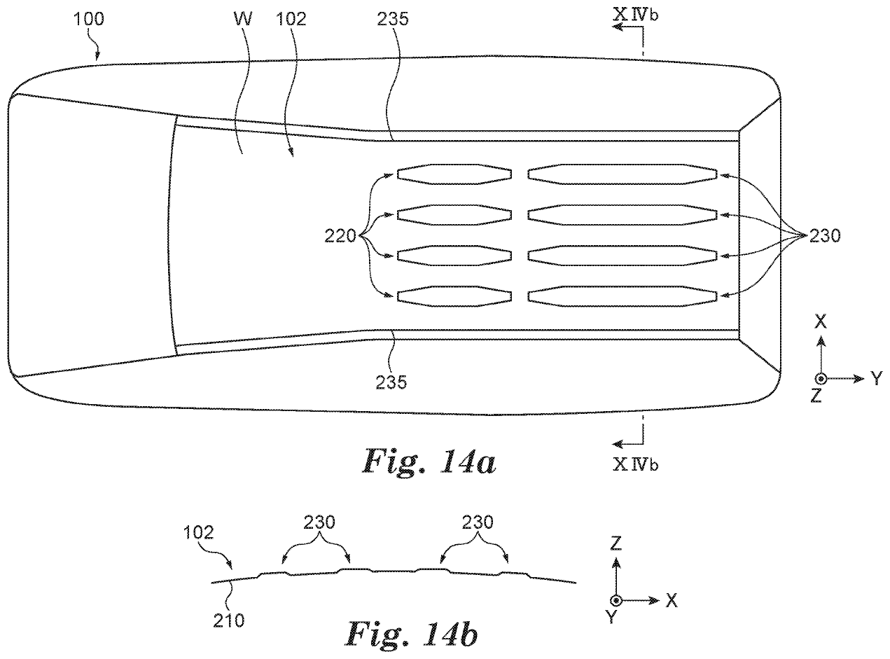

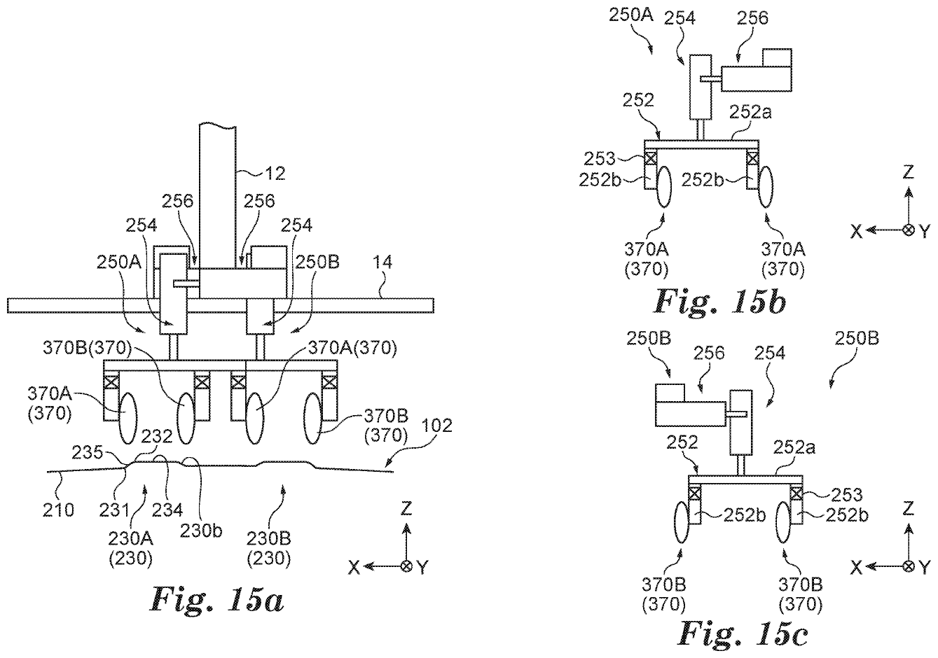

The film W may be applied to the roof 102 of the vehicle 100 as illustrated in FIGS. 14a and 14b. In FIGS. 14a and 14b, beads 220 and 230 each having a shape upwardly projecting from a main body part 210 (see FIG. 14b) are formed. A plurality of (here, four) beads 220 and a plurality of (here, four) 230 are arrayed in the X-axis direction. The beads 220 and the beads 230 are formed to be spaced apart from each other in the Y-axis direction (FIG. 14a). Each of the beads 220 and 230 has such a shape that tip end portions on both sides in the Y-axis direction are tapered. Beads 235 are formed on the roof 102. The beads 235 extend in the Y-axis direction, along edge portions on both sides in the X-axis direction. Note that, as illustrated in FIG. 15a, the bead 230 includes a flat surface portion 234 extending in a shape of a substantially flat surface at a position higher than the main body part 210, and a pair of inclined portions 235 inclined from the main body part 210 toward the flat surface portion 234. The shape of the continuously extending main body part 210 and the shape of each of the inclined portions 235 continuously inclined at a predetermined angle are discontinuous at discontinuous portions 231. The shape of the continuously extending flat surface portion 234 and the shape of each of the inclined portions 235 continuously inclined at a predetermined angle are discontinuous at discontinuous portions 232.

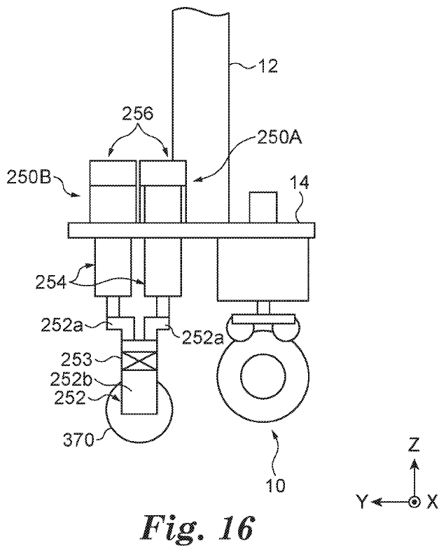

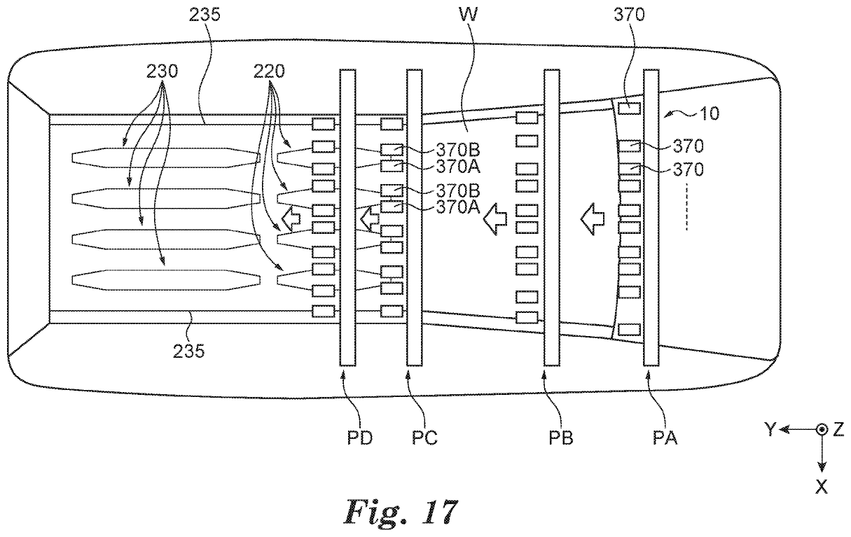

In this case, second rollers 370 as illustrated in FIG. 15a to FIG. 17 may be adopted. As illustrated in FIG. 15a and FIG. 17, the second roller 370 according to the present modified example includes a plurality of second rollers 370, and the plurality of second rollers 370 are provided in the X-axis direction. As illustrated in FIG. 16 and FIG. 17, the second rollers 370 are disposed on an upstream side of the first roller 10 in a moving direction in the Y-axis direction. As illustrated in FIG. 15a, the film application apparatus 1 includes a first roller unit 370A and a second roller unit 370B by dividing the second rollers 370 in the X-axis direction. Further, the first roller unit 370A and the second roller unit 370B are capable of positional adjustment in the X-axis direction.

Note that, in FIG. 15a to FIG. 17, individual second rollers 370 are schematically illustrated. However, an individual second roller 370 may adopt a shape of including the large diameter part 76 as in the second roller 70 illustrated in FIG. 9a to FIG. 11c. In this case, the apex portion 761 may press the discontinuous portion 231 of the bead 230, the inclined portion 763 may press the inclined portion 235, a portion between the inclined portion 763 and the outer end portion 75a may press the discontinuous portion 232, and the outer end portion 75a of the main body part 75 may press the flat surface portion 234. Note that the second rollers 370 may have a configuration of the second roller 170 illustrated in FIGS. 12a to 12f.

With reference to FIGS. 15a to 15c and FIG. 16, configurations of the first roller unit 370A and the second roller unit 370B will be described. Note that, as illustrated in FIG. 15a, the bead 230 on the positive side in the X-axis direction may be referred to as a bead 230A, and the bead 230 on the negative side in the X-axis direction may be referred to as a bead 230B.

As illustrated in FIG. 15a, a first roller mechanism 250A is disposed further on the positive side in the X-axis direction than a second roller mechanism 250B. The first roller mechanism 250A can use one second roller 370 to press a portion near the discontinuous portion 231 of the bead 230A on the positive side in the X-axis direction, and can use another second roller 370 to press a portion near the discontinuous portion 231 of the bead 230B on the positive side in the X-axis direction. Such a pair of second rollers 370 constitutes the first roller unit 370A. The second roller mechanism 250B is disposed further on the negative side in the X-axis direction than the first roller mechanism 250A. The second roller mechanism 250B can use one second roller 370 to press a portion near the discontinuous portion 231 of the bead 230A on the negative side in the X-axis direction, and can use another second roller 370 to press a portion near the discontinuous portion 231 of the bead 230B on the negative side in the X-axis direction. Such a pair of second rollers 370 constitutes the second roller unit 370B.

As illustrated in FIG. 15b, the first roller mechanism 250A includes a support frame 252 that supports the pair of second rollers 370 such that the pair of second rollers 370 is spaced apart in the X-axis direction, a cylinder 254 that moves the support frame 252 in the vertical direction, and a cylinder 256 that moves the cylinder 254 in the X-axis direction. The cylinder 256 is provided on the negative side of the cylinder 254 in the X-axis direction, and is attached to the support member 14 (see FIG. 15a). The support frame 252 includes a frame main body part 252a supported by the cylinder 254 and extending in the X-axis direction, and a pair of support parts 252b extending downward from both end sides of the frame main body part 252a. The second rollers 370 are supported at lower end portions of the support parts 252b. Note that a spring part 253 is formed at each of the support parts 252b. The spring part 253 is extended and retracted due to pressing of the second roller 370. As illustrated in FIG. 15c, when seen in the Y-axis direction, the second roller mechanism 250B has a laterally inverted configuration of the first roller mechanism 250A, with respect to the YZ plane.

As illustrated in FIG. 16, the first roller mechanism 250A and the second roller mechanism 250B are disposed to be shifted from each other in the Y-axis direction so that their respective cylinders 256 extending in the X-axis direction do not interfere with each other. The first roller mechanism 250A is disposed on the negative side in the Y-axis direction, and the second roller mechanism 250B is disposed on the positive side in the Y-axis direction. Note that the second rollers 370 of the first roller mechanism 250A and the second rollers 370 of the second roller mechanism 250B are coaxially disposed so as to overlap each other, when seen in the X-axis direction. The frame main body part 252a of the first roller mechanism 250A and the frame main body part 252a of the second roller mechanism 250B are disposed to be spaced apart from each other in the Y-axis direction. The support parts 252b and the second rollers 370 of the first roller mechanism 250A shift toward the positive side in the Y-axis direction, and the support parts 252b and the second rollers 370 of the second roller mechanism 250B shift toward the negative side in the Y-axis direction.

With the configuration as described above, when positional adjustment of the second rollers 370 in the X-axis direction is performed with respect to the discontinuous portions 231 of the beads 230A and 230B on the positive side in the X-axis direction, the cylinder 256 of the first roller mechanism 250A is driven. When positional adjustment of the second rollers 370 in the X-axis direction is performed with respect to the discontinuous portions 231 of the beads 230A and 230B on the negative side in the X-axis direction, the cylinder 256 of the second roller mechanism 250B is driven.

With reference to FIG. 17, a procedure of applying the film W by using the rollers 10 and 370 will be described. In FIG. 17, the positions of the rollers 10 and 370 are illustrated in four stages. At a position PA, a state when application is started by using the rollers 10 and 370 is illustrated. At a position PB, a state of the rollers 10 and 370 before reaching the beads 220 is illustrated. At a position PC, a state of the rollers 10 and 370 pressing tapered portions of the beads 220 is illustrated. At a position PD, a state of the rollers 10 and 370 pressing straight-extending portions of the beads 220 is illustrated.

A film application method includes a first pressing and moving step, and a second pressing and moving step. The first pressing and moving step is a step of pressing the film W disposed on an upper side of the roof 102 from above by using the first roller 10 extending in the X-axis direction, and moving in the Y-axis direction. The second pressing and moving step is a step of pressing the film W disposed on an upper side of the roof 102 from above by using the second rollers 370 extending in the X-axis direction, and moving in the Y-axis direction. In the second pressing and moving step, the second rollers 370 are disposed on an upstream side of the first roller 10 in a moving direction in the Y-axis direction. The first roller unit 370A and second roller unit 370B are provided by dividing the second rollers 370 in the X-axis direction (see FIGS. 15a to 15c). Further, positional adjustment of the first roller unit 370A and the second roller unit 370B is performed in the X-axis direction.

Specifically, as illustrated at the position PA, the rollers 10 and 370 are set on a front side of a front end portion of the roof 102. Next, as illustrated at the position PB, on an upstream side in a moving direction, a pair of second rollers 370 at both end portions presses the film W toward the beads 235. Then, on a downstream side in the moving direction, the rollers 370 press the entire film W. Next, as illustrated at the position PC, on an upstream side in the moving direction, positional adjustment of the first roller unit 370A and the second roller unit 370B is performed. In this manner, respective second rollers 370 press the film W toward tapered edge portions of the beads 220. The positions of the tapered edge portions of the beads 220 shift in the X-axis direction, as the positions shift toward the positive side in the Y-axis direction. Thus, respective roller units 370A and 370B move in the X-axis direction so as to be kept in line with the shifted positions of the edge portions of the beads 220, as the respective roller units 370A and 370B move toward the positive side in the Y-axis direction. Then, on a downstream side in the moving direction, the rollers 370 press the entire film W. Next, as illustrated at the position PD, on an upstream side in the moving direction, positional adjustment of the first roller unit 370A and the second roller unit 370B is performed. In this manner, respective second rollers 370 press the film W toward edge portions of straight-extending portions of the beads 220. Then, on a downstream side in the moving direction, the rollers 370 press the entire film W. Note that the rollers 10 and 370 also perform pressing for the beads 230, with operation similar to the operation performed for the beads 220.

As described above, the second roller 370 illustrated in FIG. 15a to FIG. 17 includes a plurality of second rollers 370, and the plurality of second rollers 370 are provided in the X-axis direction. In this case, the second rollers 370 can partially press a position as a pressing target. Specifically, the second rollers 370 can partially press portions near edge portions of the beads 220 and 230. Thus, the second roller 370 can perform pressing in a pressing manner appropriate for such portions. As one example, a wide area of the roof 102 is collectively pressed by the second rollers 370. In this case, although pressure may be excessive depending on a pressing portion, the second rollers 370 can perform pressing with pressure necessary for target portions.

The second rollers 370 are disposed on an upstream side of the first roller 10 in a moving direction in the Y-axis direction. Unlike the beads 120A and 120B illustrated in FIGS. 6a to 6c, the bead 220 and the bead 230 are disposed to be separated with a gap in the Y-axis direction. In this case, at the time of application, air is liable to be trapped between the film W and the roof 102 in the area between the bead 220 and the bead 230. In light of this, when the second rollers 370 may be disposed on an upstream side in a moving direction, the second rollers 370 perform application to the beads 220 and 230 prior to the first roller 10, and this results in that air can be prevented from being trapped when the first roller 10 applies the film W to the entire roof 102.

The film application apparatus 1 includes the first roller unit 370A and the second roller unit 370B by dividing the second rollers 370 in the X-axis direction. Further, the first roller unit 370A and the second roller unit 370B are capable of positional adjustment in the X-axis direction. In this case, when positions shift in the X-axis direction as the positions shift in the Y-axis direction similarly to the tapered edge portions of the beads 220 and 230, the film application apparatus 1 perform application by simultaneously performing positional adjustment of respective roller units 370A and 370B in the X-axis direction. In this manner, the film application apparatus 1 can keep in line with the shifted positions of the beads 220 and 230 in the X-axis direction.

A film application method includes a first pressing and moving step, and a second pressing and moving step. The first pressing and moving step is a step of pressing the film W disposed on an upper side of the roof 102 from above by using the first roller 10 extending in the X-axis direction, and moving in the Y-axis direction. The second pressing and moving step is a step of pressing the film W disposed on an upper side of the roof 102 from above by using the second rollers 370 extending in the X-axis direction, and moving in the Y-axis direction. In the second pressing and moving step, the second rollers 370 are disposed on an upstream side of the first roller 10 in a moving direction in the Y-axis direction. The first roller unit 370A and second roller unit 370B are provided by dividing the second rollers 370 in the X-axis direction (see FIGS. 15a to 15c). Further, positional adjustment of the first roller unit 370A and the second roller unit 370B is performed in the X-axis direction. In this case, similarly to the film application apparatus 1 described above, application is performed by simultaneously performing positional adjustment of respective roller units 370A and 370B in the X-axis direction. In this manner, respective roller units 370A and 370B can keep in line with shifted positions of the beads 220 and 230 in the X-axis direction.

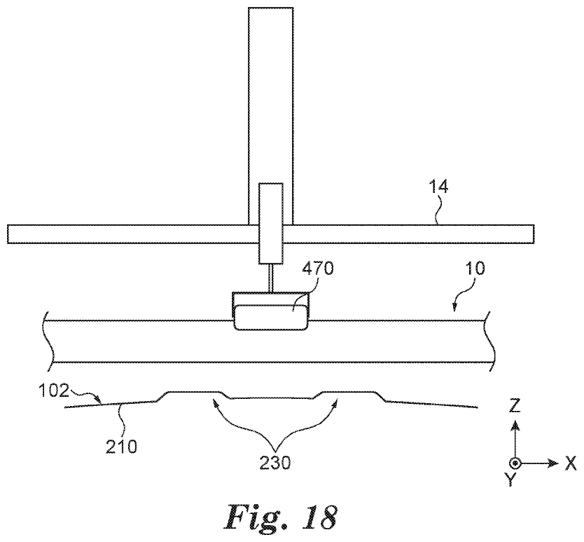

Note that the following configuration may be employed. Specifically, as illustrated in FIG. 18, a second roller 470 presses the main body part 210 between a pair of beads 230, and both end portions of the second roller 470 in the X-axis direction press edge portions of the respective beads 230.

Note that, in the description above, both the first roller unit 370A and the second roller unit 370B are capable of positional adjustment in the X-axis direction. However, only one of the first roller unit 370A and the second roller unit 370B may be capable of positional adjustment.

It is sufficient that the film application apparatus includes at least the first roller or the second roller. The width direction film application units 3A and 3B may be omitted.

Note that, in the embodiment described above, a vehicle is exemplified as a target object of film application. However, a target object is not only limited to a vehicle, and any object may be a target object of film application. For example, a target object may be a train, a flying object, a piece of furniture, and an electrical appliance.

1. A film application apparatus for applying a film to a target object, the film application apparatus comprising:
a first roller extending in a first direction intersecting a vertical direction, the first roller being configured to press the film disposed on an upper side of the target object from above, and being configured to move in a second direction intersecting the first direction and the vertical direction; and
a second roller extending in the first direction, the second roller being configured to press the film disposed on an upper side of the target object from above, and being configured to move in the second direction, wherein
the second roller is disposed on at least one of an upstream side and a downstream side of the first roller in a moving direction in the second direction.

2. The film application apparatus according to claim 1, wherein
the second roller includes a portion having different hardness along the first direction.

3. The film application apparatus according to claim 2, wherein
the portion having different hardness is formed at a portion of the second roller corresponding to a discontinuous portion of a recessed and projecting shape of the target object, and is harder than at least a part of another portion.

4. The film application apparatus according to claim 1, wherein
the target object has a recessed and projecting shape, and a portion of the second roller corresponding to a discontinuous portion of the recessed and projecting shape is harder than the first roller.

5. The film application apparatus according to claim 1, wherein
the second roller is capable of changing a relative position with respect to the first roller, in the vertical direction.

6. The film application apparatus according to claim 1, wherein
the second roller includes a plurality of second rollers, and the plurality of second rollers are provided in the first direction.

7. The film application apparatus according to claim 1, wherein
the second roller includes a large diameter part, at which a diameter is increased at a part in the first direction.

8. The film application apparatus according to claim 1, wherein
the second roller includes a first layer, and a second layer on an outer peripheral side, the first layer and the second layer being formed in a radial direction, and being formed of materials different from each other.

9. The film application apparatus according to claim 8, wherein
the first layer of the second roller has a thickness varying depending on a position in the first direction.

10. The film application apparatus according to claim 8, wherein
the second layer of the second roller has a thickness varying depending on a position in the first direction, the thickness being defined by a dimension between an outer peripheral surface of the first layer and an outer peripheral surface of the second layer.

11. The film application apparatus according to claim 1, wherein
the second roller is disposed on an upstream side of the first roller in a moving direction in the second direction.

12. The film application apparatus according to claim 1, wherein
the second roller is disposed on a downstream side of the first roller in a moving direction in the second direction.

13. The film application apparatus according to claim 1, wherein
the film application apparatus comprises at least a first roller unit and a second roller unit by dividing the second roller in the first direction, and
at least one of the first roller unit and the second roller unit is capable of positional adjustment in the first direction.

14. A film application method for applying a film to a target object, the film application method comprising:
a first pressing and moving step of pressing the film disposed on an upper side of the target object from above by using a first roller extending in a first direction intersecting a vertical direction, and moving in a second direction intersecting the first direction and the vertical direction; and
a second pressing and moving step of pressing the film disposed on an upper side of the target object from above by using a second roller extending in the first direction, and moving in the second direction, wherein
in the second pressing and moving step,
the second rollers are disposed on at least one of an upstream side and a downstream side of the first roller in a moving direction in the second direction,
at least a first roller unit and a second roller unit are provided by dividing the second roller in the first direction, and
positional adjustment of the first roller unit and the second roller unit is performed in the first direction.
